(19) United States
(12) Patent Application Publication
(10) Pub. No.: US 2026/0111845 A1
(43) Pub. Date: Apr. 23, 2026

(54) METHOD AND SYSTEM FOR COLLABORATIVE CREATIVITY ENHANCEMENT

(71) Applicant: International Business Machines Corporation, Armonk, NY (US)

(72) Inventors: Jessica Nahulan, Markham (CA); Martin G. Keen, Cary, NC (US); Jeremy R. Fox, Georgetown, TX (US); Fernando Luiz Koch, Palm Beach Gardens, FL (US)

(73) Assignee: International Business Machines Corporation, Armonk, NY (US)

(21) Appl. No.: 18/924,117

(22) Filed: Oct. 23, 2024

(51) Int. Cl. G06Q 10/101; H04L 67/306

(52) U.S. Cl. CPC G06Q 10/101; H04L 67/306

(57) ABSTRACT

Input data is received from users participating in a collaborative session and analyzed to determine and classify a creativity context of the session. A repository of personalized creative profiles is maintained, a personalized creative profile in the repository corresponding to a user in the plurality of users. A creative suggestion is generated, where the creative suggestion is made contextually relevant to the collaborative session using the creativity context from the analyzed input data, and is personalized to a user by using a personalized creative profile of the user from the repository. The creative suggestion is refined using a relevance filtering mechanism. A user feedback is collected relative to the creative suggestion and an AI assistant is updated using the user feedback, to cause a change in the generating operation such that a future creative suggestion improves an engagement of the user in the collaborative session.

### BACKGROUND

Artificial intelligence (AI) has increasingly become integral to enhancing productivity, creativity, and collaboration in digital environments. The use of large language models (LLMs) and adaptive AI systems has shown promise in transforming how individuals and teams interact during creative processes. Such systems are capable of generating context-aware suggestions and adapting their outputs to the specific needs and preferences of users, making them valuable tools for innovation and creativity.

Existing collaborative creativity systems often lack the dynamic adaptability required to provide personalized and contextually relevant assistance. While traditional AI assistants can perform predefined tasks, they typically do not leverage user-specific data and real-time context effectively. These systems may fail to deliver optimal creative support due to their inability to continuously learn from user interactions and adapt to the evolving context of collaborative sessions.

### SUMMARY

The illustrative embodiments provide for an adaptive system for enhancing collaborative creativity using AI-driven technologies. An embodiment includes receiving input data from a plurality of users participating in a collaborative session. The embodiment further includes analyzing the input data by determining a creativity context. The embodiment further includes classifying the creativity context. The embodiment further includes maintaining a repository of personalized creative profiles, a personalized creative profile in the repository corresponding to a user in the plurality of users. The embodiment further includes generating a creative suggestion, wherein the generating makes the creative suggestion contextually relevant to the collaborative session using the creativity context from the analyzed input data, and wherein the generating makes the creative suggestion personalized to a user by further using from the repository at least one personalized creative profile corresponding to the user. The embodiment further includes refining the creative suggestion using a relevance filtering mechanism. The embodiment further includes collecting, from the user, a user feedback relative to the creative suggestion. The embodiment further includes updating an AI assistant, using the user feedback, to cause a change in the generating operation such that a future creative suggestion improves an engagement of the user in the collaborative session.

An embodiment includes a computer-usable program product. The program product includes a computer-readable storage medium and program instructions stored on the storage medium for execution.

An embodiment includes a computer system. The computer system comprises a processor, computer-readable memory, and storage medium, with program instructions stored for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example adaptive creativity enhancement system in accordance with an illustrative embodiment;

FIG. 3A depicts a block diagram of an example collaborative system environment in accordance with an illustrative embodiment;

FIG. 3B depicts a process of operation of an Adaptive Creative AI Assistant, in accordance with an illustrative embodiment;.

FIG. 4A depicts a block diagram of an example collaborative enhancement environment in accordance with an illustrative embodiment;

FIG. 4B depicts a process of operation of a Creativity Context Manager, in accordance with an illustrative embodiment;

FIG. 5A depicts a block diagram of an example adaptive AI-assisted creativity platform in accordance with an illustrative embodiment;

FIG. 5B depicts a process of operation of a Personalized Creative Profile Repository, in accordance with an illustrative embodiment;

FIG. 6 depicts a block diagram of an example natural language processing (NLP) system in accordance with an illustrative embodiment;

FIG. 7 depicts a block diagram of an example machine learning enhancement system in accordance with an illustrative embodiment;

FIG. 8 depicts a block diagram of an example language model integration system process in accordance with an illustrative embodiment;

FIG. 9 depicts a block diagram of an example LLM integration system in accordance with an illustrative embodiment; and

FIG. 10 depicts a flowchart of an example process 1001 for generating contextually relevant and personalized creative suggestions in accordance with an illustrative embodiment.

### DETAILED DESCRIPTION

The state of the art in the relevant field focuses on enhancing user interactions through various forms of artificial intelligence, specifically chatbots and conversation analysis systems. These systems are designed to process and analyze user input to derive intent, improve communication efficiency, and facilitate multi-channel conversations. Prior art, such as U.S. Pat. No. 11,005,06B2, involves using AI models to derive user intent and respond via chatbots. Other inventions, such as US20200125805A1, emphasize human-to-human conversation analysis, extracting insights from customer service interactions to potentially automate certain tasks. Additional prior art, like U.S. Pat. No. 11,303,589B2, focuses on increasing communication flexibility using integrated chatbot platforms and various resources, including natural language processing and machine learning. These systems aim to improve user experience, reduce response time, and allow non-programmers to create customized chatbots.

In at least one embodiment, focuses on enhancing collaborative creativity through an adaptive AI assistant powered by LLMs. Unlike existing chatbot systems or conversation analysis platforms that primarily focus on intent recognition, communication speed, or conversation analysis, embodiments generate personalized and contextually relevant creative suggestions in real-time to foster innovation. In at least one embodiment, leveraging techniques such as continuous user input analysis, adaptive learning, and mediation of creative conflicts, more dynamic and productive brainstorming sessions, tailored to individual user preferences and collaborative needs, are enabled.

At least one embodiment provides a specific and practical application of artificial intelligence, utilizing advanced machine learning algorithms and large language models to generate personalized, contextually relevant creative suggestions in collaborative settings. At least one embodiment goes beyond basic data processing or generic AI interaction by employing novel techniques such as adaptive learning, real-time contextual analysis, and creative conflict mediation, all of which contribute to an improved and tangible innovation process. In at least one embodiment, a technical implementation offers substantial improvements over conventional brainstorming and creativity-enhancing methods.

Embodiments are described in terms of functional components, which are described in appropriate terminology. For example, Personalized Creative Suggestions are Creative ideas or prompts tailored to the specific preferences, styles, and needs of individual users. Personalization is achieved by referencing user profiles that store past creative behaviors, preferences, and feedback, allowing the assistant to generate suggestions that align with each user's unique style and requirements.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

A collaborative session refers to an interactive, real-time brainstorming or creative process where multiple users engage with one another. During a collaborative session, participants may share ideas, provide input, and/or collaborate on problem-solving or innovation tasks. In at least one embodiment an AI assistant offers personalized, contextually relevant suggestions to enhance creativity and facilitate productive discussions.

Context-enhancing information refers to clarifications, creative ideas, and imaginative suggestions that are enhanced to consider personalization to the unique preferences and requirements of individual users.

A Creativity Context Manager (CCM) describes a system component that continuously monitors and interprets the ongoing creative session by analyzing user interactions, conversation history, and the topic being discussed. The CCM updates the “creativity context” in real time to ensure that suggestions made by the AI assistant are relevant to the current discussion.

A Personalized Creative Profile Repository (PCPR) is a database that stores detailed profiles for each user participating in a collaborative session. These profiles include information about the user's past creative work, style preferences, and feedback history, allowing the system to generate suggestions that are specifically tailored to each user's creative tendencies.

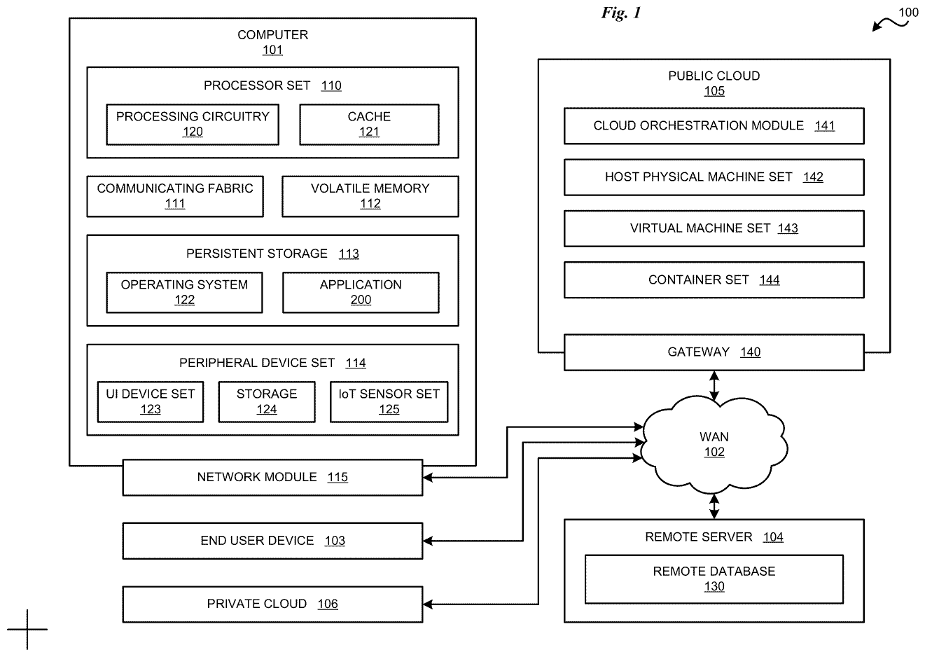

With reference to FIG. 1, this figure depicts a block diagram of a computing environment 100. Computing environment 100 contains an example of an environment for the execution of at least some of the computer code involved in performing the inventive methods, such as an improved network management module 200 that provides insights into a network's performance and characteristics of network usage, and provides incentives to network users for reducing or avoiding excessive network usage. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

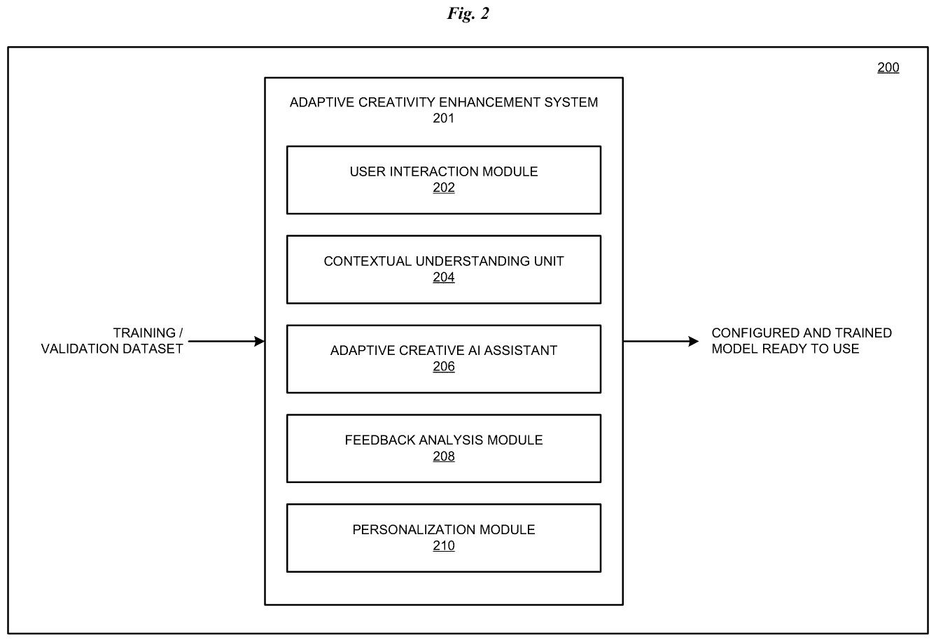

With reference to FIG. 2, this figure depicts a block diagram of an adaptive creativity enhancement system 201 in accordance with an illustrative embodiment. Adaptive systems use machine learning and reinforcement learning to refine their suggestion mechanisms. An adaptive creative system analyzes contextual hints, user tastes, and interactions to provide personalized creative prompts. In the illustrated embodiment, system 201 is designed to integrate collaborative and adaptive AI technologies to facilitate creativity processes through an LLM.

Reinforcement Learning refers to a machine learning approach where the AI system improves its performance by receiving feedback on its suggestions. In this case, user feedback on creative suggestions is collected and used to refine the assistant's algorithms, enabling it to generate increasingly relevant and high-quality suggestions over time.

System 201 includes several core components: user interaction module 202, creativity context manager 204, adaptive creative AI assistant 206, feedback analysis module 208, and personalization module 210. These components work together to create a comprehensive platform for enhancing collaborative creativity.

User interaction module 202 serves as the interface between the system and the end user. User interaction module 202 captures input personalized information by observing user interactions, including verbal, textual, and behavioral data, to further provide ongoing personal data for system 201.

Creativity context manager 204 processes user inputs collected by user interaction module 202. This unit leverages large language models and natural language processing techniques to interpret the context of collaborative sessions, maintaining an updated understanding of user objectives and session dynamics.

Real-time for a process, as applied to data which is updated and stored, implies a time scale, of availability of new data, which corresponds to usability of new data for the process. Interpreting real-time data refers to a process of connecting the data with a context.

A user objective refers to a goal, preferred by an individual, in the interest of contributing to a collaborative session. Session dynamics refer to interaction between users during collaborative sessions.

Adaptive creative AI assistant 206 utilizes insights from the creativity context manager 204 to generate suggestions that align with the objectives of an ongoing collaborative session. Adaptive creative AI assistant 206 adapts, on the basis of information provided by user interaction module 202 to user inputs. Assistant 206 evolves suggestions during ongoing collaborative processes. Insights refer to conclusions drawn by, or data otherwise distilled, through an NLP process as conducted by creativity context manager 204.

In embodiments, feedback analysis module 208 collects feedback, concerning user satisfaction with the collaborative session, directly from users during collaborative sessions. it monitors user responses to AI-generated suggestions and analyzes this data to refine the output of adaptive creative AI assistant 206.

The Personalization Module 210 is configured to modify AI-generated suggestions according to the individualized preferences and profiles of users. These profiles may include data such as prior interactions with the system, specific creative styles, thematic preferences, and user feedback history. The profiles are typically created and maintained through user interaction over time and are stored in a dedicated Personalized Creative Profile Repository (PCPR). The scope of “creative preferences” encompasses parameters such as preferred brainstorming approaches, content themes, and stylistic tendencies, but does not extend to areas outside user-defined creative boundaries or technical constraints. The Personalization Module 210 is part of the system illustrated in FIG. 2, which processes this profile data to generate suggestions customized to the user's needs. The system then delivers these suggestions to the user, typically via a user interface or interaction platform. The terms “relevant” and “engaging” are quantitatively defined based on the alignment of generated suggestions with the user's predefined preferences, context of the collaborative session, and the ability to prompt further meaningful interaction within the session. These metrics can be measured through system feedback mechanisms, such as user response rate or the acceptance of suggestions.

The interaction among these components allows the system 201 to provide a dynamic and adaptive platform that enhances the creative output of users by continuously learning and refining its processes.

In this embodiment, the adaptive creativity enhancement system 201 integrates a vast knowledge base, real-time interaction capabilities, and AI-driven adaptability to support and optimize collaborative brainstorming sessions, ensuring contextually relevant and personalized creative outputs.

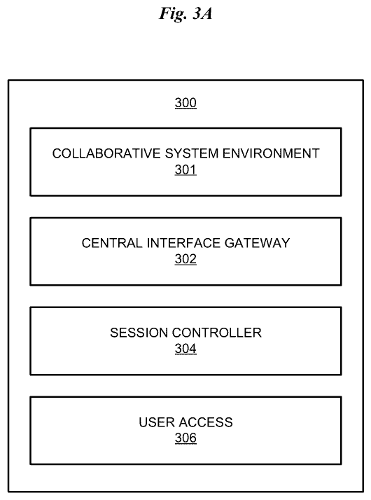

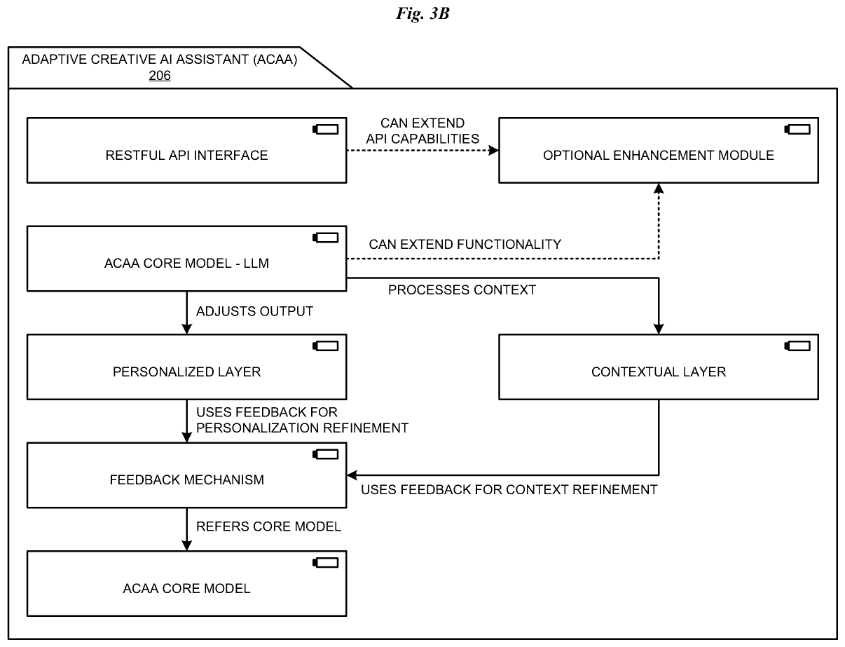

FIG. 3A illustrates a block diagram of a collaborative system environment 301 designed in accordance with an illustrative embodiment. This environment integrates a collaborative management system 300, providing the primary infrastructure for facilitating communication, collaboration, and resource management.

The collaborative environment 301 includes a central interface gateway 302, which acts as the main access point for various user systems 306. This gateway 302 manages and secures data exchanges, enabling efficient and scalable interactions among multiple users.

Within the environment, the session controller 304 operates as the central monitoring component, overseeing user sessions and interaction metrics. This controller 304 coordinates closely with the collaborative management system 300 to manage resources dynamically based on user input and activity patterns captured by the interface gateway 302.

The collaborative management system 300 features an adaptive suggestion engine that integrates real-time user data and feedback. This engine provides enhanced recommendations and interaction strategies, adapting to user behavior to maximize efficiency and effectiveness within collaborative sessions.

The environment also supports an extended connectivity framework, allowing external systems to integrate seamlessly with the collaborative platform via secure protocols managed by the interface gateway 302. This extension facilitates wider accessibility and interaction beyond the primary organizational boundaries, creating a comprehensive and interconnected collaborative ecosystem.

The adaptive suggestion engine within the collaborative management system 300 ensures continuous optimization of collaborative activities. This is achieved by applying advanced learning models that process user feedback and dynamically adjust interaction approaches to foster a productive and innovative collaborative experience.

FIG. 3B illustrates operation of the adaptive creative AI assistant 206, in accordance with at least one embodiment.

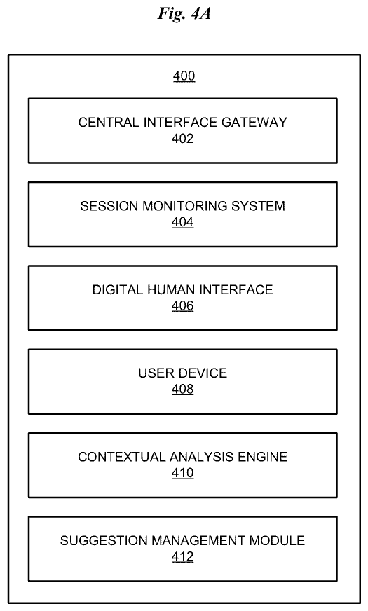

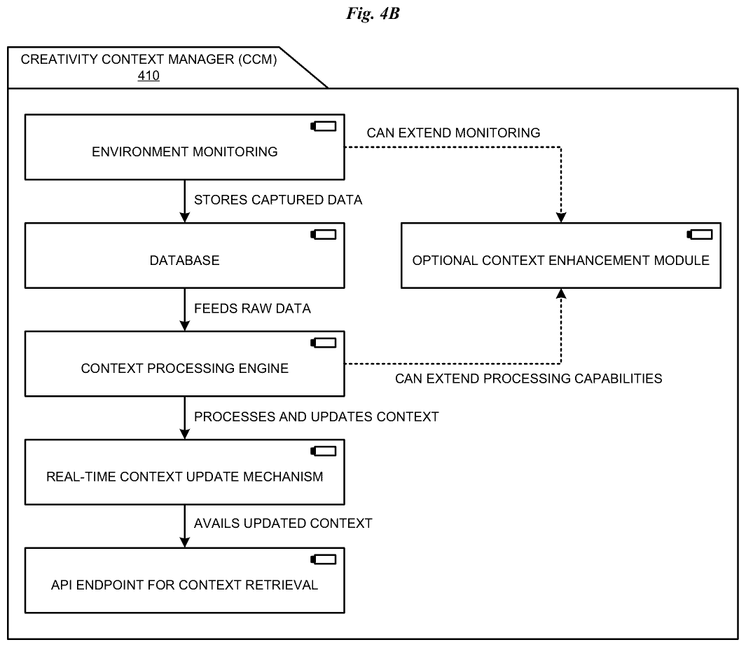

Referring to FIG. 4A, this figure illustrates a block diagram of collaborative enhancement environment 401 in accordance with an illustrative embodiment. This environment integrates an innovation facilitation module 400, enabling advanced management of creative processes, user interactions, and collaborative tools.

Collaborative enhancement environment 401 provides access via central interface gateway 402, allowing user devices 408 to interact securely with the innovation facilitation module 400. gateway 402 serves as the primary access point for facilitating dynamic, real-time collaboration among multiple users.

Environment 401 includes session monitoring system 404 that tracks ongoing collaborative sessions and manages resources dynamically. This monitoring system works closely with innovation facilitation module 400 to ensure that user activity remains synchronized, enabling seamless engagement and real-time feedback. Session monitoring system 404 is similar to adaptive creative AI assistant 206.

Innovation facilitation module 400 features an adaptive AI assistant that uses reinforcement learning algorithms to generate personalized creative suggestions based on contextual analysis and user preferences. This AI assistant continuously optimizes the innovation process by integrating real-time data and user feedback.

In addition, the environment supports digital human interface 406, which assists in mediating creative conflicts by understanding user input and dynamically adapting interaction strategies to maintain a productive collaborative atmosphere. This interface leverages large language models to facilitate brainstorming and enhance creative outcomes.

The environment also includes creativity context manager (or contextual analysis engine) 410 that filters suggestions based on relevance, ensuring that outputs are personalized and aligned with user goals. This engine processes user data and adapts recommendations during collaborative sessions to maintain high engagement levels and optimize the creativity process. creativity context manager 410 is similar to the creativity context manager 204.

The interface gateway 402 enables integration with external systems, allowing users from various networks or organizational units to join shared sessions securely. This creates a broader, interconnected collaborative environment that supports diverse and innovative idea generation.

The suggestion management module 412 within the innovation facilitation module 400 ensures continuous improvement of the creative process by incorporating various idea generation techniques. This module refines outputs through reinforcement learning and user-centric feedback mechanisms to maintain a contextually relevant and productive collaborative environment.

FIG. 4B illustrates operation of the creativity context manager 410, in accordance with at least one embodiment, where creativity context manager (CCM) or context processing engine is contextual analysis engine 410, captured data is stored in collaborative environment 401, by session monitoring system 404, environment monitoring is performed by session monitoring system 404, database—store various user-related data and suggestions from user devices 408, optional context enhancement module storing are processing elements, in embodiments, extending contextual analysis engine 410. Real-time context update mechanism provides real-time feedback and data integration capabilities of adaptive AI assistant 206. API endpoint for context retrieval is gateway 402.

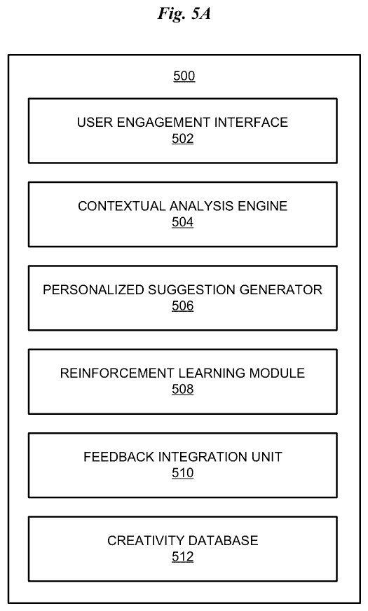

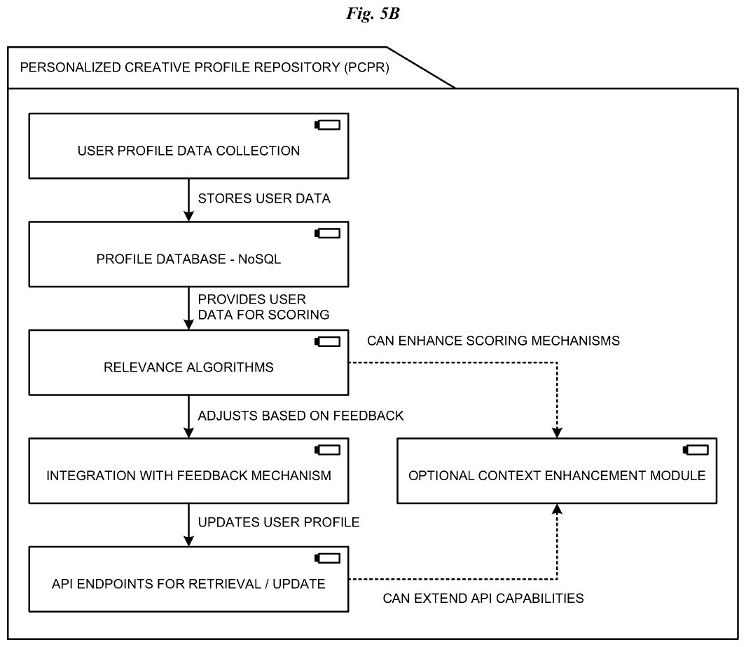

With reference to FIG. 5A, this figure illustrates a block diagram of an example adaptive AI-assisted creativity platform 501, which is similar to system 201. The platform 501 integrates multiple components designed to enhance and streamline the innovation process within collaborative environments using LLMs and advanced reinforcement learning techniques.

In this embodiment, platform 501 includes several key components: user engagement interface 502, contextual analysis engine 504, personalized suggestion generator 506, reinforcement learning module 508, feedback integration unit 510, and personalized creative profile repository (or creativity database) 512. Personalized suggestion generator 506 is similar to adaptive creative AI assistant 206. These components collaborate to create an adaptive and dynamic environment that optimizes user interactions and facilitates creativity. Contextual analysis engine 504 is similar to contextual analysis engine 410.

User engagement interface 502 collects real-time data from users, including inputs such as text, voice, and behavioral data during collaborative sessions. This module captures ongoing user interactions to facilitate the generation of personalized creative prompts.

Contextual analysis engine 504 processes the data collected by user engagement interface 502. it evaluates the context of the collaborative session by analyzing user inputs, session history, and conversation patterns to provide relevant information for personalized suggestion generator 506.

Personalized suggestion generator 506 uses insights from the contextual analysis engine 504 to generate creative suggestions tailored to the specific needs and preferences of individual users. Generator 506 leverages LLMs and contextual data to deliver suggestions that are contextually relevant and adapt dynamically to the changing dynamics of the collaborative session.

Reinforcement learning module 508 continuously refines the suggestion-generation algorithms based on real-time user feedback. it integrates data from feedback integration unit 510 to adjust the AI model parameters, ensuring that the system remains responsive and enhances its suggestion accuracy and relevance over time.

Feedback integration unit 510 monitors and processes feedback from users during sessions. this component collects and evaluates user responses to AI-generated suggestions, providing critical data to the reinforcement learning module 508 for continuous optimization.

Personalized creative profile repository 512 stores diverse creative prompts, templates, and user profiles. It serves as a repository for the platform, enabling the system to draw from a vast knowledge base to enhance the creativity support provided. This database ensures that the suggestions generated by the platform are aligned with the users'needs and collaborative goals.

The interaction of these components allows platform 501 to function as a comprehensive solution for enhancing innovation processes. The integration of real-time data analysis, user engagement tracking, and adaptive learning models enables the system to offer a dynamic, user-centric approach to fostering creativity in collaborative settings.

In this configuration, the adaptive AI-assisted creativity platform 501 supports a wide range of industries and applications where collaborative creativity is essential. By employing LLMs, personalized suggestion algorithms, and reinforcement learning techniques, the platform creates an environment that optimizes productivity and drives innovation.

FIG. 5B depicts operation of personalized creative profile repository and personalized suggestion generator 506, where personalized creative profile repository (PCPR) corresponds to the creativity database 512, user data is stored in creativity database 512, user profile data collection occurs at user engagement interface 502. Profile database NoSQL is part of creativity database 512, which functions as a repository for creative data and user profiles, in embodiments utilizing a NoSQL structure. Optional context enhancement module is, in embodiments, an extension of the contextual analysis engine 504. Relevance algorithms execute in suggestion generator 506, which uses context and relevance filtering to generate suggestions tailored to individual users. Integration with feedback mechanism is performed by feedback integration unit 510. API endpoints for retrieval/update are part of user engagement interface 502.

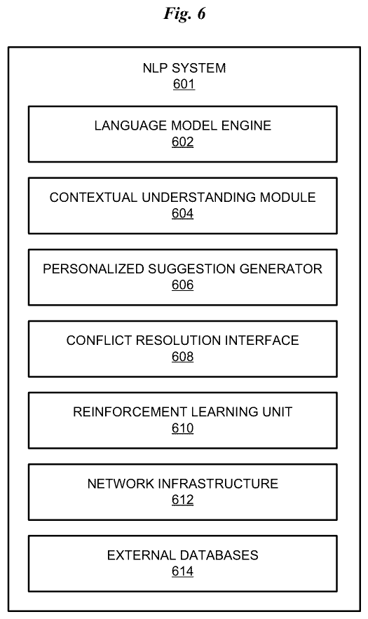

With reference to FIG. 6, this figure depicts a block diagram of an example natural language processing (NLP) system 601 in accordance with an illustrative embodiment. The NLP system 601 is an example of an integrated module for enhancing collaborative creativity through advanced AI capabilities, similar to the collaborative framework specified in FIG. 5.

In the illustrated embodiment, the NLP system 601 includes language model engine 602, contextual understanding module 604, personalized suggestion generator 606, conflict resolution interface 608, and reinforcement learning unit 610. NLP system 601 operates in conjunction with network infrastructure 612 and receives monitored data from multiple sources. In alternative embodiments, NLP system 601 may integrate these functionalities differently, either distributed across software and hardware solutions or as application-specific configurations. Contextual understanding module 604 is similar to the adaptive creative AI assistant 206.

Language model engine 602 processes user input from various collaborative sessions, analyzing textual data and conversation patterns. The language model engine leverages advanced language models, such as LLMs, to comprehend and generate contextually relevant creative suggestions based on ongoing interactions.

The contextual understanding module 604 gathers and processes input from the language model engine 602 and external sources. It identifies the topic being discussed, tracks conversation history, and captures contextual cues to inform the system's responses dynamically.

The personalized suggestion generator 606 tailors creative suggestions by analyzing user preferences stored in a user profile database. The generator refines its outputs based on real-time interaction data, adjusting its recommendations to align with individual user styles and preferences, ensuring relevant and impactful suggestions during collaborative creativity sessions.

Conflict resolution interface 608 uses AI-driven digital human capabilities to mediate disagreements during brainstorming sessions. By analyzing divergent viewpoints and utilizing semantic analysis, the interface proposes compromise solutions, blending the most beneficial elements of each perspective to facilitate harmonious collaboration.

In at least one embodiment, Mediated Conflict Resolution refers to a process where an AI assistant analyzes conflicting ideas or viewpoints during a collaborative brainstorming session and proposes compromise solutions. The assistant identifies common ground between divergent perspectives and offers solutions that combine the strengths of each idea, facilitating a harmonious and productive resolution.

Reinforcement learning unit 610 continuously adapts the suggestion-generation algorithms by integrating user feedback. By employing reinforcement learning techniques, this unit ensures that the system evolves and improves its ability to offer relevant and personalized suggestions tailored to the dynamic needs of users in collaborative settings.

In some embodiments, NLP system 601 may also interface with external databases 614 to access historical data, user profiles, and additional resources. These databases support the enhancement of language model engine 602 and personalized suggestion generator 606, enabling a robust and adaptive collaborative environment. external databases 614 perform the functionality of personalized creative profile repository 512.

NLP system 601 further supports a real-time feedback loop, where users can evaluate and respond to the suggestions generated. This feedback is processed and analyzed by reinforcement learning unit 610, enabling the system to refine its output continuously and enhance the overall user experience in collaborative creativity sessions.

In this configuration, NLP system 601 provides a comprehensive framework for leveraging AI to enhance innovation processes. By integrating advanced natural language processing capabilities, personalized suggestion generation, and AI-driven mediation, the system creates a dynamic and adaptive environment that optimizes user engagement and productivity.

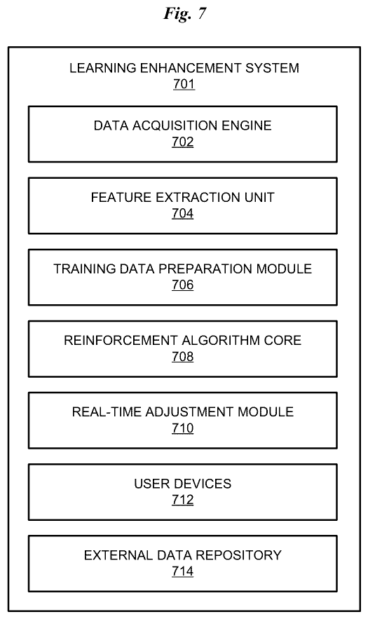

With reference to FIG. 7, this figure illustrates a block diagram of an example machine learning enhancement system 701 according to an illustrative embodiment. Machine learning enhancement system 701 integrates reinforcement learning module 700, which is structured to optimize and adapt collaborative creativity processes within the environment.

In the illustrated embodiment, system 701 includes data acquisition engine 702, feature extraction unit 704, training data preparation module 706, reinforcement algorithm core 708, and real-time adjustment module 710. System 701 interfaces with user devices 712 and external data repository 714 for continuous data flow and monitoring. In alternative embodiments, system 701 may be distributed across multiple software and hardware configurations, including application-specific integrated circuits (ASICs) and cloud-based services. Feature extraction unit 704 performs functions similar to adaptive creative AI assistant 206.

Data acquisition engine 702 collects input data from various sources within the collaborative environment. This data includes user interactions, feedback, and contextual information, which is then processed to generate training datasets.

Feature extraction unit 704 analyzes the incoming data, identifying key variables and patterns essential for model training. It applies dimensionality reduction techniques and transformation processes to prepare the data for input into the training data preparation module 706.

Training data preparation module 706 structures datasets for reinforcement algorithm core 708. This module utilizes normalization techniques, noise reduction, and data cleaning methods to optimize the quality of the data fed into the algorithm.

Reinforcement algorithm core 708 implements various reinforcement learning techniques to refine suggestion-generation models. It applies Q-learning and other adaptive methods to enhance the system's ability to generate contextually relevant and personalized creative suggestions based on real-time user feedback.

Real-time adjustment module 710 continuously monitors the performance of reinforcement algorithm core 708. It dynamically adjusts model parameters and suggestions in response to live feedback from user devices 712, ensuring that the system remains responsive and adaptive throughout collaborative sessions.

System 701 also interfaces with external data repository 714, which houses historical user profiles, feedback logs, and previous interaction data. This repository supports reinforcement algorithm core 708 by providing additional data points for refining suggestion models and enhancing the overall accuracy and relevance of the system's outputs.

Real-time adjustment module 710 further integrates with user feedback loops, allowing users to directly influence model refinement processes. This continuous feedback is processed and incorporated into the reinforcement learning pathways to optimize creativity enhancement strategies dynamically.

In this configuration, machine learning enhancement system 701 offers a comprehensive framework for leveraging reinforcement learning to drive collaborative innovation. By integrating real-time data, user feedback, and adaptive algorithms, the system ensures an optimized, user-centric approach to enhancing creativity and productivity in collaborative settings.

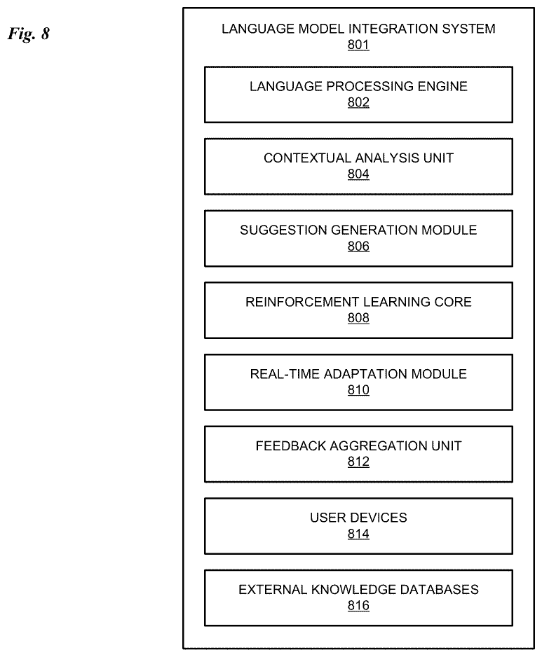

With reference to FIG. 8, this figure depicts a block diagram of example language model integration system 801 in accordance with an illustrative embodiment. Language model integration system 801 utilizes advanced AI capabilities, particularly LLMs, to enhance collaborative creativity by generating contextually relevant and personalized suggestions based on user interactions.

In the illustrated embodiment, LLM integration system 801 includes language processing engine 802, contextual analysis unit 804, suggestion generation module 806, reinforcement learning core 808, real-time adaptation module 810, and feedback aggregation unit 812. The system interfaces with user devices 814 and external knowledge databases 816 for continuous interaction and monitoring. In alternative embodiments, these functionalities may be distributed across multiple hardware and software configurations, utilizing cloud-based services and AI-driven solutions. Contextual analysis unit 804 performs functions similar to adaptive creative AI assistant 206.

Language processing engine 802 leverages LLMs to comprehend and process user input from collaborative sessions. It analyzes textual data to generate real-time suggestions that align with ongoing discussions.

Contextual analysis unit 804 extracts and processes information from user interactions, analyzing the historical and current conversation context. It interprets user intentions and engagement levels to provide language processing engine 802 with the necessary context for generating relevant suggestions.

The suggestion generation module 806 tailors outputs based on user profiles and preferences stored in system 801's knowledge databases 816. This module integrates semantic and contextual data to ensure suggestions are personalized, context-aware, and optimized for enhancing collaborative outcomes.

Reinforcement learning core 808 continuously refines the models used by suggestion generation module 806. It employs reinforcement learning techniques to adjust suggestion algorithms based on user feedback, ensuring that outputs are continually improved.

Real-time adaptation module 810 monitors user engagement and interaction patterns, dynamically adjusting system parameters to optimize user experience. It ensures that the system's outputs remain relevant throughout collaborative sessions.

Feedback aggregation unit 812 collects data from user responses and engagement metrics, integrating this information into reinforcement learning core 808. This feedback loop allows the system to learn and adapt its outputs based on real-time user preferences and interaction history.

System 801 interfaces with external knowledge databases 816, accessing a repository of information that supports the generation of creative and contextually relevant suggestions. These databases store user profiles, historical interaction data, and creative prompts that inform language processing engine 802 and suggestion generation module 806.

Language model integration system 801 provides a comprehensive framework for enhancing innovation processes in collaborative environments. By leveraging advanced natural language processing techniques and large language models, the system dynamically adapts to user needs, ensuring a personalized and productive user experience.

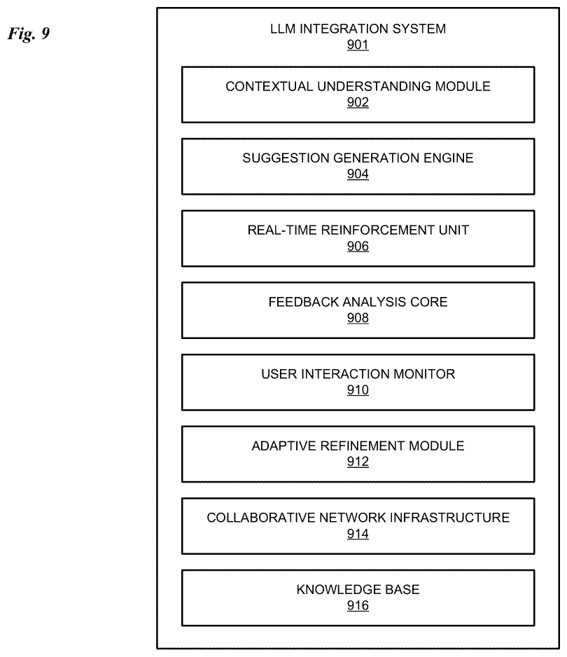

With reference to FIG. 9, this figure depicts a block diagram of example LLM integration system 901 in accordance with an illustrative embodiment. LLM integration system 901 is designed to enhance collaborative creativity processes by leveraging advanced NLP techniques and large language models.

System 901 includes several components: contextual understanding module 902, suggestion generation engine 904, real-time reinforcement unit 906, feedback analysis core 908, user interaction monitor 910, and adaptive refinement module 912. These components interact with collaborative network infrastructure 914 and access data from external sources through knowledge base 916. Suggestion generation engine performs functions similar to the adaptive creative AI assistant 206.

Contextual understanding module 902 processes and interprets user interactions and conversation history, providing contextual information to suggestion generation engine 904. This module captures the semantic and situational context of discussions, ensuring that suggestions generated align with the current collaborative environment.

Suggestion generation engine 904 utilizes LLMs to produce personalized and contextually relevant creative suggestions based on inputs from contextual understanding module 902. It adapts its outputs by analyzing the user's engagement and preferences stored within knowledge base 916.

Real-time reinforcement unit 906 continuously optimizes suggestion generation engine 904 using reinforcement learning algorithms. It integrates feedback from user interaction monitor 910 and feedback analysis core 908 to dynamically adjust parameters and improve suggestion accuracy.

Feedback analysis core 908 collects and processes user feedback during collaborative sessions. It assesses the quality and relevance of suggestions made by suggestion generation engine 904, providing data to the real-time reinforcement unit 906 for further refinement.

User interaction monitor 910 tracks user engagement and response patterns in real time. This component identifies interaction trends and provides metrics that inform adaptive refinement module 912 to adjust system behavior and improve the overall user experience.

Adaptive refinement module 912 integrates data from user interaction monitor 910 and feedback analysis core 908, fine-tuning the system's outputs based on real-time user data. This module ensures the system remains responsive and adapts continuously to user needs and evolving collaborative dynamics.

Knowledge base 916 contains extensive data repositories, including user profiles, historical interaction records, and creative suggestion templates. This information supports contextual understanding module 902 and suggestion generation engine 904, enhancing the system's ability to deliver personalized and relevant creative outputs.

In this configuration, LLM integration system 901 offers a comprehensive solution for enhancing collaborative creativity using large language models and NLP techniques. By incorporating continuous feedback, real-time adaptation, and personalized content generation, the system optimizes productivity and creativity within collaborative settings.

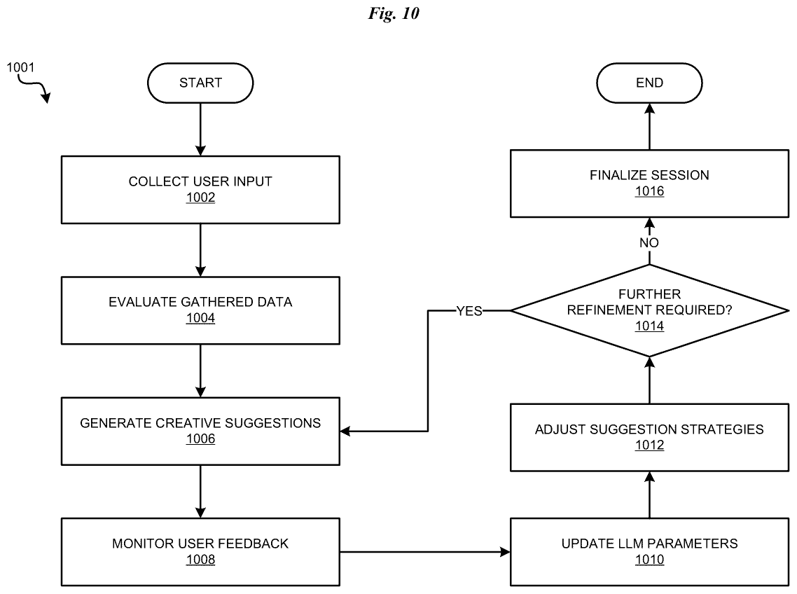

With reference to FIG. 10, this figure depicts a flowchart of example process 1001 for generating contextually relevant and personalized creative suggestions using an LLM in a collaborative environment, according to an illustrative embodiment. The process is implemented within a collaborative innovation framework and utilizes the advanced AI capabilities discussed in prior figures.

At block 1002, the process begins by collecting user input from various sources, including typed messages, spoken queries, and interaction data from the collaborative environment. The input is processed to extract key information such as conversation topics, user preferences, and historical context, leveraging an NLP engine.

At block 1004, the process uses the contextual analysis module to evaluate the gathered data. The module integrates conversation history and contextual cues to create a real-time representation of the collaborative environment. This analysis informs the suggestion generation engine, ensuring that outputs are aligned with user goals and current session dynamics.

At block 1006, the system generates initial creative suggestions using the LLM. The suggestion generator incorporates the contextual data from block 1004 and applies personalization layers based on stored user profiles. This ensures that the creative suggestions are not only contextually relevant but also tailored to individual user preferences.

At block 1008, the system monitors user feedback through engagement metrics and direct feedback inputs. The feedback data is analyzed to evaluate the effectiveness and relevance of the generated suggestions. The user interaction monitor continuously tracks engagement levels, providing critical data for refining the suggestion process.

At block 1010, the process enters a reinforcement learning phase, where it updates the LLM's parameters based on the user feedback collected in block 1008. This step uses reinforcement learning algorithms to optimize the suggestion generation mechanism iteratively, improving future outputs in real time.

At block 1012, the process adjusts suggestion strategies based on evolving user needs and session dynamics. The adaptive module fine-tunes the LLM's parameters to reflect the real-time feedback received, ensuring that the system remains responsive and effective throughout the collaborative session.

At block 1014, the system revisits the user interaction and contextual data to verify if further refinement is required. If additional iterations are necessary, the process loops back to block 1006, continuing the cycle of suggestion generation and optimization. Otherwise, the process concludes, ensuring all output aligns with user preferences and collaboration goals.

At block 1016, the process finalizes the session by documenting the creative output, storing the interaction history and user preferences in the database. This information is used for future sessions to enhance the context-aware suggestion generation, maintaining a repository of knowledge that supports the collaborative environment's long-term effectiveness.

The flowchart illustrates a methodical approach where the AI system leverages continuous user input and feedback, adaptive learning models, and personalization techniques, ensuring that the collaborative environment supports innovation processes effectively.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method, comprising:
receiving input data from a plurality of users participating in a collaborative session;
analyzing the input data by determining a creativity context;
classifying the creativity context;
maintaining a repository of personalized creative profiles, a personalized creative profile in the repository corresponding to a user in the plurality of users;
generating a creative suggestion, wherein the generating makes the creative suggestion contextually relevant to the collaborative session using the creativity context from the analyzed input data, and wherein the generating makes the creative suggestion personalized to a user by further using from the repository at least one personalized creative profile corresponding to the user;
refining the creative suggestion using a relevance filtering mechanism;
collecting, from the user, a user feedback relative to the creative suggestion ;
updating an AI assistant, using the user feedback, to cause a change in the generating operation such that a future creative suggestion improves an engagement of the user in the collaborative session.

2. The computer-implemented method of claim 1, wherein the input data comprises at least one of a user preference of the user, a historical creative work of the user, and a contextual information related to the collaborative session.

3. The computer-implemented method of claim 1, wherein the creativity context is based on at least one of a conversation history in the collaborative session, a topic being discussed, in the collaborative session.

4. The computer-implemented method of claim 1, wherein the personalized creative profile of the user comprises at least one of data describing a past creative contribution of the user, a style preference of the user, and a feedback history of the user.

5. The computer-implemented method of claim 1, wherein the relevance filtering mechanism further comprises:
cross-referencing current session context with a stored user preference of the user.

6. The computer-implemented method of claim 1, wherein collecting the user feedback further comprises:
iteratively optimizing, using a reinforcement learning algorithm, an output of the AI assistant.

7. The computer-implemented method of claim 1, wherein the updating is based on a real-time context detected in the collaborative session.

8. A computer program product comprising one or more computer readable storage media, and program instructions collectively stored on the one or more computer readable storage media, the program instructions executable by a processor to cause the processor to perform operations comprising:
receiving input data from a plurality of users participating in a collaborative session;
analyzing the input data by determining a creativity context;
classifying the creativity context;
maintaining a repository of personalized creative profiles, a personalized creative profile in the repository corresponding to a user in the plurality of users;
generating a creative suggestion, wherein the generating makes the creative suggestion contextually relevant to the collaborative session using the creativity context from the analyzed input data, and wherein the generating makes the creative suggestion personalized to a user by further using from the repository at least one personalized creative profile corresponding to the user;
refining the creative suggestion using a relevance filtering mechanism;
collecting, from the user, a user feedback relative to the creative suggestion ;
updating an AI assistant, using the user feedback, to cause a change in the generating operation such that a future creative suggestion improves an engagement of the user in the collaborative session.

9. The computer program product of claim 8, wherein the input data comprises at least one of a user preference of the user, a historical creative work of the user, and a contextual information related to the collaborative session.

10. The computer program product of claim 8, wherein the creativity context is based on at least one of a conversation history in the collaborative session, a topic being discussed, in the collaborative session.

11. The computer program product of claim 8, wherein the personalized creative profile of the user comprises at least one of data describing a past creative contribution of the user, a style preference of the user, and a feedback history of the user.

12. The computer program product of claim 8, wherein the relevance filtering mechanism further comprises:
cross-referencing current session context with a stored user preference of the user.

13. The computer program product of claim 8, wherein collecting the user feedback further comprises:
iteratively optimizing, using a reinforcement learning algorithm, an output of the AI assistant.

14. The computer program product of claim 8, wherein the updating is based on a real-time context detected in the collaborative session.

15. The computer program product of claim 8, wherein the stored program instructions are stored in a computer readable storage device in a data processing system, and wherein the stored program instructions are transferred over a network from a remote data processing system.

16. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

17. A computer system comprising a processor and one or more computer readable storage media, and program instructions collectively stored on the one or more computer readable storage media, the program instructions executable by the processor to cause the processor to perform operations comprising:
receiving input data from a plurality of users participating in a collaborative session;
analyzing the input data by determining a creativity context;
classifying the creativity context;
maintaining a repository of personalized creative profiles, a personalized creative profile in the repository corresponding to a user in the plurality of users;
generating a creative suggestion, wherein the generating makes the creative suggestion contextually relevant to the collaborative session using the creativity context from the analyzed input data, and wherein the generating makes the creative suggestion personalized to a user by further using from the repository at least one personalized creative profile corresponding to the user;
refining the creative suggestion using a relevance filtering mechanism;
collecting, from the user, a user feedback relative to the creative suggestion ;
updating an AI assistant, using the user feedback, to cause a change in the generating operation such that a future creative suggestion improves an engagement of the user in the collaborative session.

18. The computer system of claim 17, wherein the input data comprises at least one of a user preference of the user, a historical creative work of the user, and a contextual information related to the collaborative session.

19. The computer system of claim 17, wherein the creativity context is based on at least one of a conversation history in the collaborative session, a topic being discussed, in the collaborative session.

20. The computer system of claim 17, wherein the personalized creative profile of the user comprises at least one of data describing a past creative contribution of the user, a style preference of the user, and a feedback history of the user.
